(19) United States
(12) Patent Application Publication
(10) Pub. No.: US 2009/0235363 A1
(43) Pub. Date: Sep. 17, 2009

(54) IMAGE FORMATION DEVICE AND LICENSE MANAGEMENT SYSTEM

(75) Inventor: Kouichi Tomita, Osaka-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc.,, Chiyoda-ku (JP)

(21) Appl. No.: 12/369,778

(22) Filed: Feb. 12, 2009

(30) Foreign Application Priority Data
Mar. 13, 2008 (JP) 2008-063824

(51) Int. Cl. G06F 9/00; G06F 21/00

(52) U.S. Cl. 726/27; 713/100

(57) ABSTRACT

An image formation device enables an optional function that is invalid in an initial state with the entry of a license code. The image formation device includes a storage part for storing specific information unique to the image formation device, and authenticates a license code input thereto using the specific information stored in the storage part. When this license code is recognized as a proper license code as a result of authentication, the image formation device enables an optional function. The image formation device also includes a function disabling part for disabling an optional function that has been enabled. Disabling the optional function causes the function disabling part to change the specific information stored in the storage part to information different from previous information. As a result, an optional function of the image formation device is prevented from being enabled many times using a license once granted to the image formation device. Further, a license management server is allowed to precisely manage the usage of a license at all times.

This application is based on the application No. 2008-063824 filed in Japan, the contents of which are hereby incorporated by reference.

### BACKGROUND OF THE INVENTION

1. Field of the Invention

The present invention relates to an image formation device for enabling an optional function that is invalid in an initial state with the entry of a license code, and a license management system including this image formation device.

2. Description of the Background Art

Conventionally known image formation devices include what are called complex devices or MFPs (multifunction peripherals). These types of devices have several functions as a copier, a scanner, a fax machine, a network printer, a box and the like. Especially in recent years, there is a trend toward an increasing number of functions to be implemented in image formation devices in response to user's needs. Under these circumstances, a user does not always require all functions implemented in the image formation device for daily doings. Hence, several function implemented in the conventionally used image formation device are divided into standard functions that are set to be effectively available in initial states, and optional functions that are set to be invalid in initial states. When a user wishes to use an optional function, the user purchases a license code, enters this license code into the image formation device to enable the optional function, thereby making this optional function usable in the image formation device.

In this case, according to a publicly known technique, device identification information unique to an image formation device is incorporated into a license granted to the user. So the granted license enables an optional function only in a device that is given device identification information coinciding with that of the granted license. This technique is disclosed for example in Japanese Patent Application Laid-Open No. 2004-213469.

According to the technique disclosed in this publication, once a license is granted, an optional function of an image formation device may be enabled many times using the granted license. This results in difficulty in managing a license actually used. These days a license management server installed in a manufacturer or a distributor remotely monitors the usage of a license at an image formation device installed in a user's office environment. Especially in this case, if a user repeatedly uses a license once granted, the license management server cannot know the proper usage of a license.

### SUMMARY OF THE INVENTION

First, the present invention is intended for an image formation device.

According to one aspect of this invention, the image formation device enables an optional function that is invalid in an initial state with the entry of a license code. The image formation device comprises: a storage part for storing specific information unique to the image formation device; an input part for receiving a license code input thereto that is generated based on the specific information; an authentication part for authenticating the license code received through the input part using the specific information stored in the storage part; a function enabling part for enabling an optional function when the authentication part recognizes the license code as a proper license code; and a function disabling part for disabling the optional function that has been enabled by the function enabling part and changing said specific information stored in said storage part.

According to this aspect, the image formation device authenticates a license code using specific information of its own. The image formation device enables an optional function when this license code is recognized as a license code properly issued for the image formation device itself. Thus, the optional function cannot be enabled with the entry of a license code issued for another device. Further, disabling an optional function causes the image formation device to change specific information that is used to authenticate a license code for enabling the optional function. Thus, the optional function cannot be enabled again using a license code that was granted before this optional function is disabled. This prevents the optional function from being enabled repeatedly using a license once granted.

Second, the present invention is intended for a license management system.

According to one aspect of this invention, the license management system comprises an image formation device and a license management server connected through a network to the image formation device. The image formation device enables an optional function that is invalid in an initial state with the entry of a license code. The license management server issues a license and transmits a license code to the image formation device, while managing the usage of a license relating to the optional function. The image formation device includes: a storage part for storing specific information unique to the image formation device; an input part for receiving a license code input thereto through the network; an authentication part for authenticating the license code received through the input part using the specific information stored in the storage part; a function enabling part for enabling an optional function when the authentication part recognizes the license code as a proper license code; and a function disabling part for disabling the optional function that has been enabled by the function enabling part. The license management server includes: a license management database for storing the usage of a license; a specific information retrieval part for retrieving the specific information stored in the storage part from the image formation device through the network; a code generation part for generating a license code used to enable an optional function based on the specific information retrieved by the specific information retrieval part; a transmission part for transmitting the license code generated by the code generation part to the image formation device; and a license management part being caused by the transmission of the license code to update the license management database. The function disabling part changes said specific information stored said storage part after disabling said optional function.

According to this aspect, the image formation device authenticates the license code generated by the license management server using specific information of its own. The image formation device enables an optional function when this license code is recognized as a license code properly issued for the image formation device itself. Thus, the optional function cannot be enabled with the entry of a license code issued for another device. Further, disabling an optional function causes the image formation device to change specific information that is used to authenticate a license code for enabling the optional function. Thus, the optional function cannot be enabled again using a license code that was granted before this optional function is disabled. This prevents the optional function from being enabled repeatedly using a license once granted. Further, the license management server is allowed to precisely manage the usage of a license at all times.

According to another aspect of this invention, the license management system comprises: an image formation device including a storage part for storing specific information unique to the image formation device, and enabling an optional function that is invalid in an initial state with the entry of a license code; a license management server issuing a license code corresponding to the optional function of the image formation device, and managing the usage of a license at the image formation device; and an information processing device so connected to the image formation device and the license management server as to realize data communication with the image formation device and the license management server. For enabling the optional function of the image formation device, the information processing device retrieves the specific information from the image formation device, and transmits a request for issue of a license code together with the specific information to the license management server. The license management server generates the license code for enabling the optional function of the image formation device based on the specific information, and transmits the license code to the information processing device. The information processing device outputs the license code received from the license management server and a function enabling command to the image formation device. The image formation device authenticates the license code received from the information processing device using the specific information stored in the storage part, and enables the optional function when the license code is recognized as a proper code. For disabling the optional function of the image formation device, the information processing device transmits a request for issue of a disabling code together with the specific information to the license management server. The license management server generates the disabling code based on the specific information, and transmits the disabling code for disabling the optional function of the image formation device to the information processing device. The information processing device outputs the disabling code received from the license management server and a function disabling command to the image formation device. The image formation device authenticates the disabling code received from the information processing device using the specific information stored in the storage part, disables the optional function when the disabling code is recognized a proper code, and changes the specific information stored in the storage part to information different from previous information.

According to this aspect, the image formation device authenticates the license code generated by the license management server using specific information of its own. The image formation device enables an optional function when this license code is recognized as a license code properly issued for the image formation device itself. Thus, the optional function cannot be enabled with the entry of a license code issued for another device. Further, disabling an optional function causes the image formation device to change specific information that is used to authenticate a license code for enabling the optional function. Thus, the optional function cannot be enabled again using a license code that was granted before this optional function is disabled. This prevents the optional function from being enabled repeatedly using a license once granted. Further, the license management server is allowed to precisely manage the usage of a license at all times. Still further, the information processing device is operated to enable or disable an optional function at the image formation device, resulting in enhanced operability.

Thus, according to the present invention, the image formation device is capable of preventing an optional function from being enabled many times using a license once granted. Further, in the license management system, the license management server is allowed to precisely manage the usage of a license at all times.

It is therefore an object of the present invention to provide an image formation device capable of preventing an optional function from being enabled many times using a license once granted, and a license management system in which a license management server is allowed to precisely manage the usage of a license at all times.

### BRIEF DESCRIPTION OF THE DRAWINGS

FIG. 1 is a schematic diagram showing the configuration of a license management system as an example of the present invention;

FIG. 2 is a block diagram showing an exemplary internal structure of a license management server;

FIG. 3 is a block diagram showing an exemplary internal structure of an information processing device;

FIG. 4 is a block diagram showing an exemplary internal structure of an image formation device;

FIG. 5 is a flow diagram showing exemplary procedures and operations for enabling an optional function that is invalid in the image formation device;

FIG. 6 shows an exemplary configuration of a license management database;

FIG. 7 shows an example of a license certificate provided from an administrator to a user;

FIG. 8 is a flow diagram showing an exemplary process sequence at the information processing device and the license management server for entering license information into the information processing device;

FIG. 9 shows an example of license information stored in a storage part of the information processing device;

FIG. 10 is a flow diagram showing an exemplary process sequence at the information processing device and the image formation device for entering device registration information into the information processing device;

FIG. 11 shows an example of the device registration information stored in the storage part of the information processing device;

FIGS. 12 and 13 are flow diagrams showing an exemplary process sequence at the information processing device, the license management server and the image formation device for enabling an optional function of the image formation device;

FIGS. 14 to 16 are flow diagrams showing an exemplary process sequence at the information processing device, the license management server and the image formation device for disabling an optional function of the image formation device; and

FIG. 17 is a flow diagram showing an exemplary transfer process of a license.

### DESCRIPTION OF THE PREFERRED EMBODIMENTS

A preferred embodiment of the present invention is described in detail below with reference to figures. In the description given below, those elements which are shared in common through the description are represented by the same reference numerals, and these elements are not discussed repeatedly for the same description.

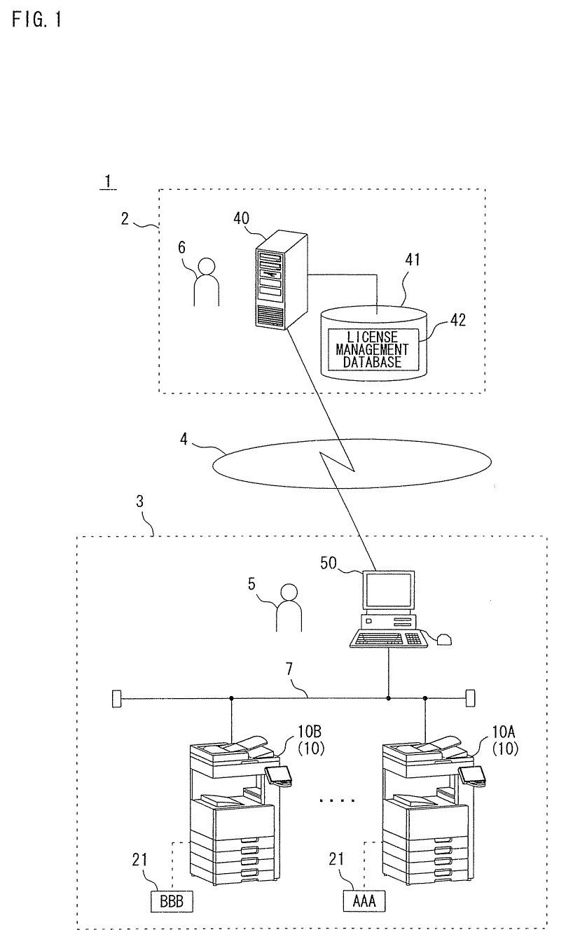

FIG. 1 is a schematic diagram showing the configuration of a license management system 1 according to the present preferred embodiment. The license management system 1 comprises a license management server 40 installed in a management center 2 such as a manufacturer or a distributor of image formation devices 10, a plurality of image formation devices 10 (including 10A and 10B) installed in a user's office environment 3, and an information processing device 50 installed in the user's office environment 3. The configuration of the license management system 1 is such that the license management server 40 of the management office 2 manages the usage of licenses at the image formation devices 10 in the user's office environment 3. The license management server 40 includes a storage part 41 such as a hard disk. A license management database 42 for storing and managing license codes issued by an administrator 6 is built in the storage part 41. In FIG. 1, several image formation devices 10 are shown to be installed in the office environment 3, whereas one image formation device 10 may be installed.

The image formation device 10 has several functions as a copier, a network printer, a scanner, a fax machine and the like, and is what is called a complex device or an MFP. In the image formation device 10, at least a predetermined function of a plurality of functions is a standard function that is set to be effectively available in an initial state, and the remaining function is an optional function that is set to be invalid in an initial state. In the present preferred embodiment, at least one optional function is implemented in the image formation device 10. When a user 5 wishes to use an optional function, the user 5 follows procedures and performs operations discussed later to enter a license code granted from the license management server 40 into the image formation device 10, thereby making this optional function valid and usable in the image formation device 10.

As shown in FIG. 1, each of the image formation devices 10 including 10A and 10B is connected to a network 7 such as a LAN, and is so configured as to realize data communication with the information processing device 50 connected to the network 7. Each of the image formation devices 10 including 10A and 10B includes therein a storage part for storing specific information 21 unique to the image formation device 10 discussed later. In the example shown in FIG. 1, “AAA” is stored as the specific information 21 in the image formation device 10A, and “BBB” is stored in the image formation device 10B. The specific information 21 is defined so that the specific information 21 is unique to each image formation device 10 at least in an environment where each image formation device 10 is connected to the network 7.

The information processing device 50 is formed for example from a generally-used PC, and is connected through a communication network 4 such as the Internet or a telephone line to the license management server 40. The information processing device 50 has a function management program installed in advance therein. The information processing device 50 executes the function management program to conduct data communication for obtaining a license code from the license management server 40 through the communication network 4, and to conduct control for enabling or disabling an optional function of the image formation device 10 connected to the network 7.

As discussed, in the present preferred embodiment, the license management server 40 conducts data communication with the image formation devices 10 indirectly through the information processing device 50 and not directly with the image formation devices 10, thereby managing the usage of licenses at the image formation devices 10.

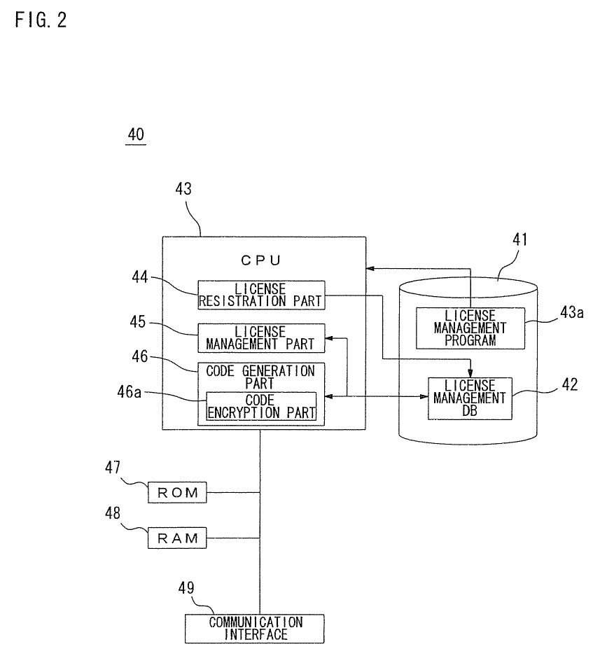

FIG. 2 is a block diagram showing the internal structure of the license management server 40. The license management server 40 has a hardware configuration formed from a CPU 43, a ROM 47, a RAM 48 and a communication interface 49 as well as the above-discussed storage part 41 that are connected to each other through a bus line. The license management server 40 may have a display device, a keyboard and the like. The storage part 41 has a license management program 43a stored therein as well as the license management database 42. The CPU 43 reads the license management program 43a from the storage part 41 and executes the same, so that the CPU 43 becomes operative to function as a license registration part 44, a license management part 45 and a code generation part 46.

The license registration part 44 enters a newly issued license into the license management database 42. The license management part 45 suitably updates the license management database 42 to always keep the usage of a license in the license management database 42 up to date. The license management part 45 causes the license management database 42 to precisely reflect the usage of a license at the user's office environment 3 for example by data communication with the information processing device 50. The code generation part 46 generates a license code for enabling an optional function of the image formation device 10, or a disabling code for disabling an optional function of the image formation device 10 again after this optional function is enabled. The code generation part 46 includes a code encryption part 46a. A code to be generated at the code generation part 46 is encrypted at the code encryption part 46a. The code encryption part 46a encrypts a license code for enabling an optional function and a disabling code for disabling an optional function using the specific information 21 of the image formation device 10 as a key.

The ROM 47 and the RAM 48 store control parameters and the like used by the CPU 43. The communication interface 49 conducts data transmission to and from the information processing device 50 through the communication network 4. The communication interface 49 is operative to function as an input part for receiving various types of information and requests from the information processing device 50, and an output part for outputting codes and various types of information to the information processing device 50.

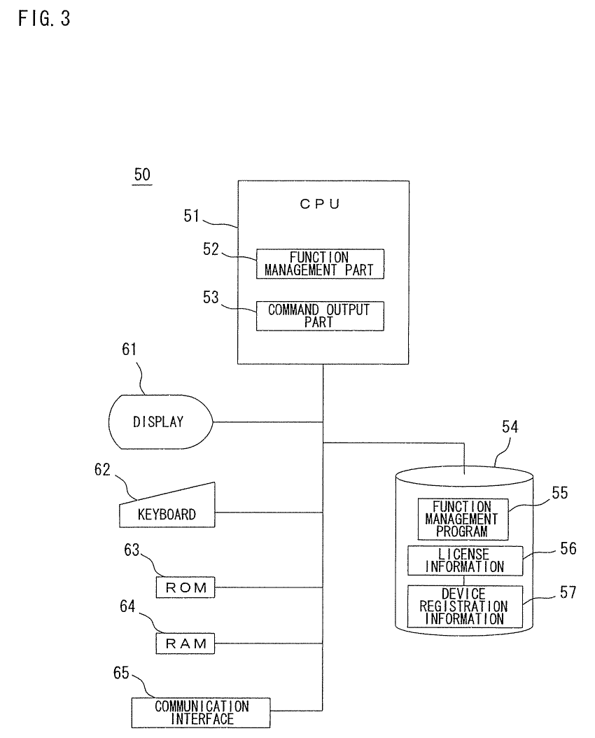

FIG. 3 is a block diagram showing the internal structure of the information processing device 50. The information processing device 50 has a hardware configuration formed from a CPU 51, a storage part 54 such as a hard disk, a display device 61, a keyboard 62, a ROM 63, a RAM 64 and a communication interface 65 that are connected to each other through a bus line. The storage part 54 has a function management program 55, license information 56 and device registration information 57 stored therein. The CPU 51 reads the function management program 55 from the storage part 54 and executes the same, so that the CPU 51 becomes operative to function as a function management part 52 and a command output part 53.

The function management part 52 conducts data communication with the license management server 40 to enter the license information 56 into the storage part 54, while conducting data communication with the image formation device 10 connected to the network 7 to obtain various types of information from the image formation device 10, thereby entering the device registration information 57 into the storage part 54 in association with the license information 56. The function management part 52 requests the license management server 40 to issue a license code and a disabling code in response to instructions from the user 5 given through the keyboard 62 and the like, and obtains these codes in encrypted form from the license management server 40.

The command output part 53 generates a function enabling command or a function disabling command regarding a particular one of the plurality of image formation devices 10 connected to the network 7, and outputs the generated command to the particular image formation device 10. A command given from the command output part 53 contains an encrypted code that the function management part 52 received from the license management server 40. The image formation device 10 that has received this command enables or disables an optional function based on the command and the encrypted code.

The display device 61 of the information processing device 50 presents various types of information to the user 5, and is formed for example from a liquid crystal display device and the like. The keyboard 62 is a manipulated input part operable by the user 5 that may also include a mouse and the like. The ROM 63 and the RAM 64 store control parameters and the like used by the CPU 51. The communication interface 65 conducts data transmission to and from the license management server 40 through the communication network 4, while conducting data transmission to and from the image formation device 10 through the network 7. The communication interface 65 is operative to function as an input part for receiving various types of information and codes from the license management server 40 and the image formation device 10, and an output part for outputting various types of requests and commands to the license management server 40 and the image formation device 10.

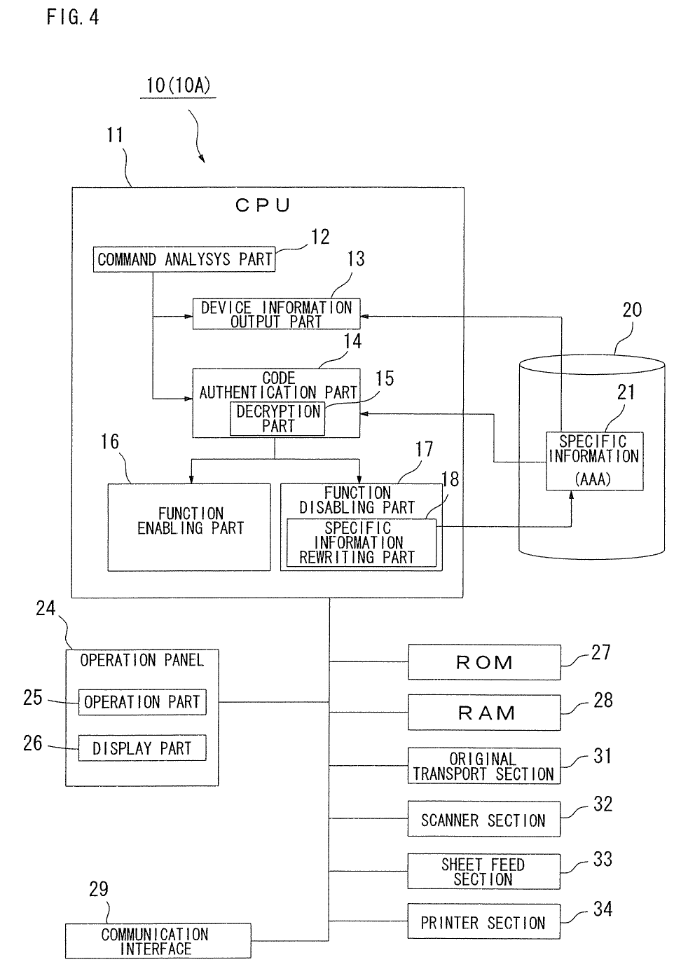

FIG. 4 is a block diagram showing the internal structure of the image formation devices 10. In FIG. 4, the structure of the image formation device 10A is shown as a representative structure. The other image formation devices 10 connected to the network 7 have the same structure as that of the image formation device 10A, with only the exception of the substance of the specific information 21. As shown in FIG. 4, the image formation device 10 includes a CPU 11 for executing a certain program to control the image formation device 10 in its entirety, a storage part 20 formed from a hard disk, a memory and the like, an operation panel 24 for allowing the user 5 to operate the image formation device 10, a ROM 27, a RAM 28, an original transport section 31, a scanner section 32, a sheet feed section 33, a printer section 34, and a communication interface 29.

The CPU 11 executes a certain program for enabling or disabling an optional function, so that the CPU 11 becomes operative to function as a command analysis part 12, a device information output part 13, a code authentication part 14, a function enabling part 16 and a function disabling part 17. The storage part 20 stores the specific information 21 uniquely defined for the image formation device 10. In FIG. 4, “AAA” is stored as the specific information 21. The specific information 21 may be rewritten by the CPU 11. The specific information 21 may alternatively be stored in the RAM 28.

Upon receipt of a command given from the information processing device 50 through the communication interface 29, the command analysis part 12 is brought into operation to analyze this command. When this command requests information relating to the image formation device 10, the command analysis part 12 brings the device information output part 13 into operation. When this command gives instructions to enable or disable an optional function, the command analysis part 12 brings the code authentication part 14 into operation, and gives an encrypted code that has been received together with the command to the code authentication part 14.

The device information output part 13 is brought into operation under instructions from the command analysis part 12, and outputs various types of information relating to the image formation device 10 to which the device information output part 13 belongs. Especially when the information processing device 50 requests specific information of the image formation device 10, the device information output part 13 reads the specific information 21 from the storage part 20, and outputs the specific information 21 thereby read.

The code authentication part 14 authenticates an encrypted code. The code authentication part 14 reads the specific information 21 stored in the storage part 20, and authenticates a received license code or a disabling code using this specific information 21. The code authentication part 14 has a decryption part 15, and decrypts an encrypted code based on the specific information 21. When the received code is successfully decrypted, the code authentication part 14 recognizes that this code is a proper code. By way of example, the code authentication part 14 decrypts a code that has been decrypted using the specific information 21 as a key. When a resultant decrypted code contains particular information such as a certain bit sequence, the code authentication part 14 recognizes the decrypted code as a proper code. When the resultant decrypted code does not contain particular information, the authentication part 14 does not recognize the decrypted code as a proper code. When the authentication part 14 recognizes the decrypted code as a proper code, the authentication part 14 brings either the function enabling part 16 or the function disabling part 17 into operation. Namely, when the code authentication part 14 authenticates a license code for enabling an optional function, the code authentication part 14 brings the function enabling part 16 into operation after code authentication. When the code authentication part 14 authenticates a disabling code for disabling an optional function, the code authentication part 14 brings the function disabling part 17 into operation after code authentication.

The function enabling part 16 enables a designated optional function of a plurality of functions of the image formation device 10 based on a function enabling code. By way of example, the function enabling part 16 enables an optional function that is invalid in an initial state, thereby making this optional function effectively available in the image formation device 10. As a result, the user 5 is allowed to use this optional function.

The function disabling part 17 disables an optional function that is effectively available in the image formation device 10 based on a function disabling code. By way of example, the function disabling part 17 disables an optional function that is effectively available in the image formation device 10, thereby making this optional function invalid again in the image formation device 10. As a result, the user 5 is prevented from using this optional function. The function disabling part 17 has a specific information rewriting part 18. The specific information rewriting part 18 rewrites the specific information 21 stored in the storage part 20 to change the specific information 21 uniquely defined for the image formation device 10. Disabling an optional function by the function disabling part 17 causes the specific information rewriting part 18 to change the specific information 21. In this case, the specific information rewriting part 18 rewrites the specific information 21 so as to make the new specific information 21 still unique to the image formation device 10 at least in an environment where the image formation device 10 is connected to the network 7.

The operation panel 24 is operated by the user 5 when the user 5 uses the image formation device 10. The operation panel 24 has a display part 26 formed from a liquid crystal display and the like for presenting various types of information to the user 5, and an operation part 25 formed from a touch panel arranged on the front side of the display part 26 and a plurality of operation buttons arranged around the display part 26. The user 5 operates the operation part 25 with reference to a screen displayed on the display part 26, so that the user 5 selects a function to be used from a plurality of functions of the image formation device 10, and makes various settings and inputs relating to the function thereby selected.

The ROM 27 and the RAM 28 store control parameters and the like used by the CPU 11. The communication interface 29 conducts data transmission to and from the information processing device 50 through the network 7. The communication interface 29 is operative to function as an input part for receiving various types of information from the information processing device 50 to enter the received information into the CPU 11, and an output part for outputting various types of information given from the CPU 11 to the information processing device 50.

The original transport section 31 receives originals placed therein when functions such as a copier, a scanner, a fax machine are used. The original transport section 31 automatically transmits originals one by one to the scanner section 32, by which the scanner section 32 optically reads characters, symbols, images and the like recorded on originals. When the image formation device 10 forms images to generate printed outputs, the sheet feed section 33 automatically feeds sheets one by one that are media on which images are to be formed to the printer section 34. The printer section 34 is brought into operation to execute jobs relating to functions such as a copier, a network printer, a fax machine and the like, and forms images on sheets fed from the sheet feed section 33 to produce printed outputs. The sections 31, 32, 33 and 34 perform the above-discussed operations when the functions are made valid in the image formation device 10. When the functions are invalid, the sections 31, 32, 33 and 34 do not perform the above-discussed operations.

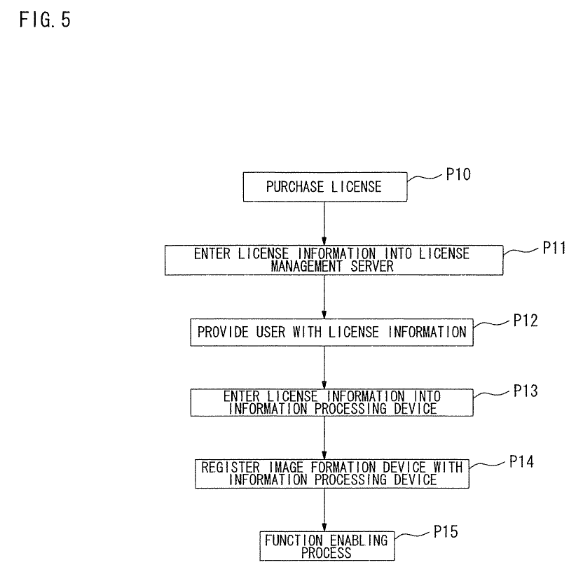

Next, it is discussed how to enable an optional function of the image formation device 10 in the license management system 1 with the configuration discussed above. FIG. 5 is a flow diagram showing procedures and operations for enabling an optional function that is invalid in the image formation device 10. First, the user 5 of the image formation device 10 follows a procedure for purchasing a certain license (process P10). By way of example, the user 5 informs the administrator 6 of an optional function the user 5 wishes to purchase, and the number of image formation devices 10 at which the optional function is intended to be used. Then the user 5 pays some fee to complete the procedure for purchasing the license. When the purchasing procedure is successfully completed, the administrator 6 issues a license code corresponding to the optional function targeted for the purchase. The license code issued at this time is used to enable an optional function that is shared by the plurality of the image formation devices 10.

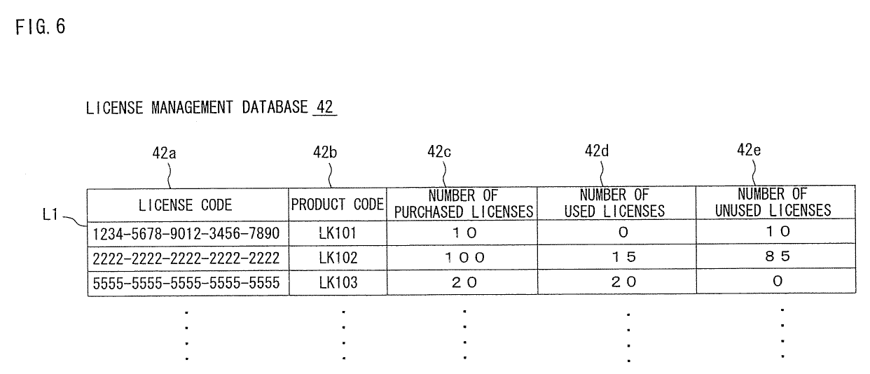

The administrator 6 enters license information containing the issued license code into the license management server 40 (process P11). At this time, in the CPU 43 of the license management server 40, the license registration part 44 is brought into operation to enter new license information given from the administrator 6 into the license management database 42. FIG. 6 shows an exemplary configuration of the license management database 42. The license management database 42 contains a license code 42a issued by the administrator 6, a product code 42b corresponding to an optional function targeted for purchase, the number of purchased licenses 42c, the number of used licenses 42d, and the number of unused licenses 42e that are recorded therein. The number of purchased licenses 42c corresponds to the number of image formation devices 10 at which a purchased optional function is intended to be used. The number of used licenses 42d is part of the number of purchased licenses 42c, and corresponds to the number of image formation devices 10 at which the optional function has already been enabled using the license indicated by the number 42d. The number of unused licenses 42e is part of the number of purchased licenses 42c, and corresponds to the number of remaining licenses that have not been used for enabling the optional function. In FIG. 6, license information L1 is assigned a license code “1234-5678-9012-3456-7890” that enables an optional function represented by a product code “LK101.” The license information L1 contains the number of purchased licenses 42c which is “10,” the number of used licenses 42d which is “0,” and the number of unused licenses 42e which is “10.” The number of used licenses 42d is “0” at the time of its entry when the license information L1 is entered in process P11, so the number of purchased licenses 42c and the number of unused licenses 42e are the same. In the present preferred embodiment, both the number of used licenses 42d and the number of unused licenses 42e are shown to be recorded in the license management database 42. However, if one of the number of used licenses 42d and the number of unused licenses 42e is recorded, the other one may be obtained by subtracting the recorded number from the number of purchased licenses 42c. Accordingly, both of these numbers are not always required to be recorded.

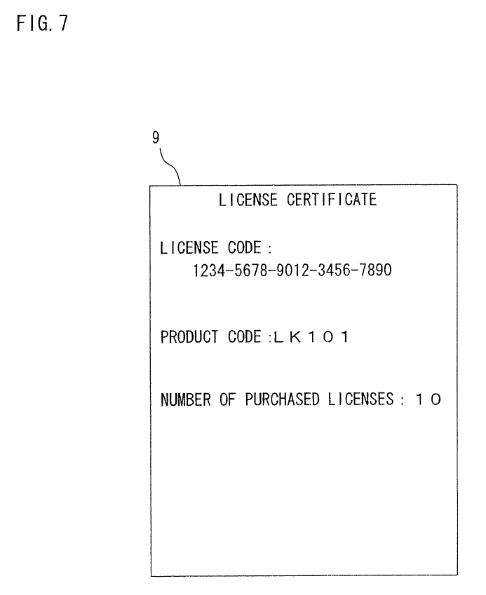

Following the process discussed above, the entry of license information into the license management server 40 is completed. Next, the administrator 6 provides the user 5 with the license information containing the issued license code (process P12). By way of example, the license information is provided from the administrator 6 to the user 5 in the form of a license certificate 9 shown in FIG. 7. The license certificate 9 includes a purchased license code, a product code corresponding to an optional function targeted for purchase, and the number of purchased licenses. Thus the user 5 is allowed to know the license code and the like by receiving the license information provided from the administrator 6. The transfer of the license certificate 9 is not the only way of provision of license information. License information may be provided in any way such as e-mail system.

When the user 5 receives the license information, the user 5 operates the information processing device 50 to enter the license information into the information processing device 50 (process P13). At this time, the user 5 inputs the license information to the information processing device 50 based on the license information described in the license certificate 9. The information processing device 50 conducts data communication with the license management server 40 in order to check whether or not the received license information conforms to license information recorded in the license management server 40. The information processing device 50 enters the received license information into the storage part 54 only when this license information conforms to the license information recorded in the license management server 40.

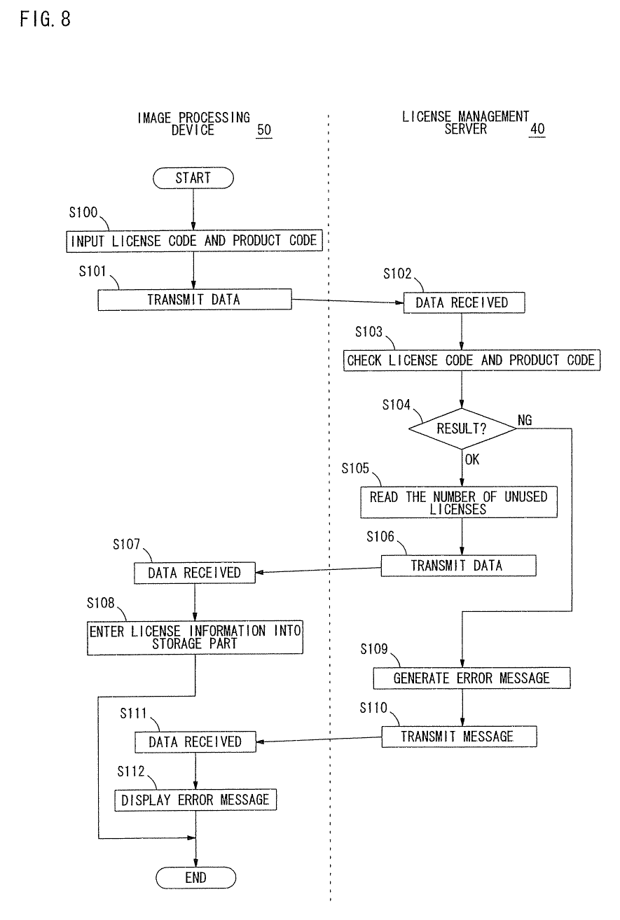

FIG. 8 is a flow diagram showing an exemplary process sequence at the information processing device 50 and the license management server 40 for entering license information into the information processing device 50. In the information processing device 50, the CPU 51 executes the function management program 55 to start this process sequence, and the function management part 52 is brought into operation in the CPU 51. The user 5 inputs a license code and a product code to the information processing device 50 based on the information in the license certificate 9 (step S100). When the input of the license code and the product code by the user 5 is completed, the information processing device 50 transmits the received license code and the product code to the license management server 40 (step S101).

In the license management server 40, upon receipt of the license code and the product code from the information processing device 50 (step S102), the license management part 45 is brought into operation in the CPU 43 to check whether or not a combination of the received license code and the product code can be found in the license management database 42 (step S103). By way of example, when the received license code is “1234-5678-9012-3456-7890” and the product code is “LK101”, the combination thereof conforms to the license information L1 shown in FIG. 6. In this case, a check result is OK. In contrast, when a combination of the received license code and the product code cannot be found in the license management database 42, a check result is NG.

The license management server 40 evaluates a check result (step S104). When the check result is OK, the license management server 40 reads the number of unused licenses 42e of the corresponding license information L1 from the license management database 42 (step S105), and transmits the number of unused licenses to the information processing device 50 (step S106).

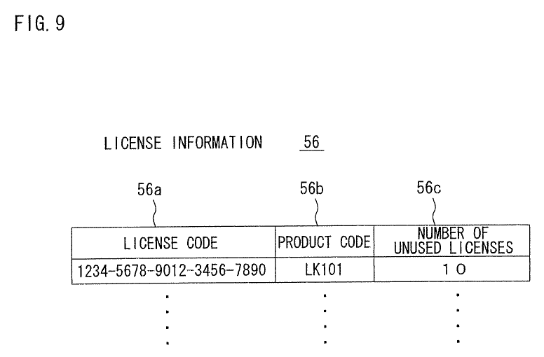

Upon receipt of the number of unused licenses from the license management server 40 (step S107), the information processing device 50 is allowed to know that the check result obtained in the license management server 40 is OK. Then, the information processing device 50 stores the license code and the product code input in step S100, and the number of unused licenses received from the license management server 40 into the storage part 54, thereby entering the license information 56 into the storage part 54 (step S108). FIG. 9 shows an example of the license information 56 thereby stored in the storage part 54 of the information processing device 50. The license information 56 contains a license code 56a, a product code 56b corresponding to an optional function, and the number of unused licenses 56c. The license code 56a, the product code 56b and the number of unused licenses 56c coincide with those of the license information L1 recorded in the license management database 42, by which consistency is maintained between the information held in the information processing device 50 and the information held in the license management database 42. When the license information 56 is successfully entered into the information processing device 50 in this way, this process for the entry is completed.

When the check result obtained in the license management server 40 is NG, on the other hand, the license management server 40 generates an error message (step S109), and transmits this error message to the information processing device 50 (step S110).

Upon receipt of the error message from the license management server 40 (step S111), the information processing device 50 is allowed to know that the check result obtained in the license management server 40 is NG. In this case, the information processing device 50 displays an error message urging the user 5 to re-enter the license code and the product code, and completes the process (step S112).

Following the process discussed above, the entry of license information into the information processing device 50 (process P13) shown in FIG. 5 is completed. The user 5 continues to operate the information processing device 50 to register the image formation device 10 with the information processing device 50 (process P14). Namely, the user 5 operates the information processing device 50, so that the information processing device 50 obtains necessary information from each of the plurality of image formation devices 10 connected to the network 7 in the office environment 3. The information processing device 50 stores the information thereby obtained as device registration information 57 into the storage part 54.

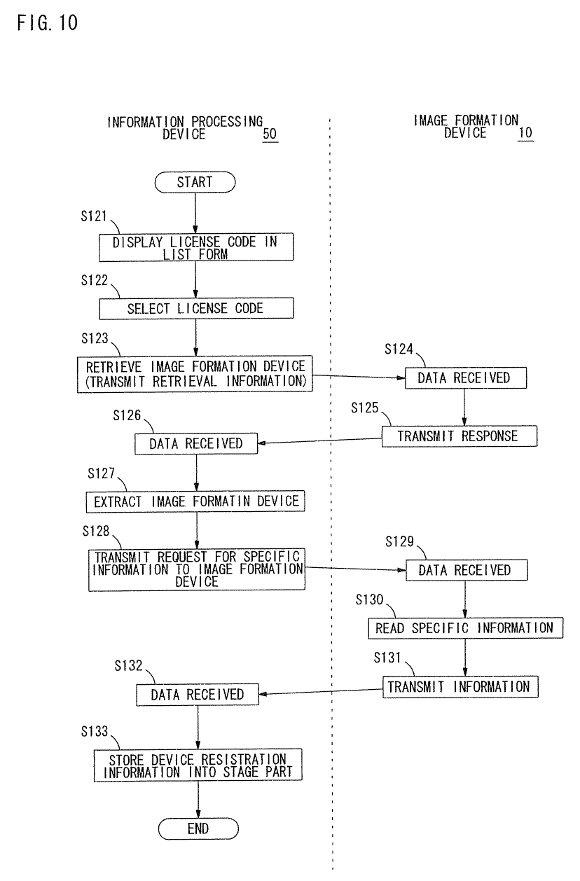

FIG. 10 is a flow diagram showing an exemplary process sequence at the information processing device 50 and the image formation device 10 for entering the device registration information 57 into the information processing device 50. In the information processing device 50, the CPU 51 also executes the function management program 55 to start this process sequence, and the function management part 52 is brought into operation in the CPU 51. After the start of the process sequence, the information processing device 50 reads the license information 56 stored in the storage part 54, and causes license codes contained in the license information 56 to be displayed in list form on the display device 61 (step S121). Then, the user 5 operates the keyboard 62 and the like to select a license code corresponding to an optional function that the user 5 wishes to enable from the license codes displayed in list form on the display device 61 (step S122).

After the user 5 selects a license code, the information processing device 50 sends retrieval information out to the network 7 in order to retrieve the image formation device 10 connected to the network 7 (step S123). By way of example, this retrieval information is broadcast to all devices connected to the network 7. In the image formation device 10, upon receipt of this retrieval information (step S124), the device information output part 13 is brought into operation in the CPU 11 to generate response information responsive to the retrieval information. Thereafter the image formation device 10 transmits the response information to the information processing device 50 (step S125). This response information contains information identifying the image formation device 10 and the like as well as the device address (IP address) or MAC address of the image formation device 10. All of the devices connected to the network 7 transmit such response information. Thus, the information processing device 50 receives not only the response information independently transmitted from each of the plurality of image formation devices 10 including 10A and 10B, but also the response information transmitted from other devices such as PCs connected to the network 7, if any. The response information transmitted from the image formation device 10 differs from the response information transmitted from a device that is not the image formation device 10.

Upon receipt of the response information through the network 7 (step S126), the information processing device 50 determines from the information contained in the received response information whether or not the received response information has been given from the image formation device 10. The information processing device 50 holds only the response information given from the image formation device 10, thereby extracting all of the image formation devices 10 connected to the network 7 (step S127). In the present preferred embodiment, the response information given from the image formation devices including 10A and 10B are held to thereby extract the image formation devices including 10A and 10B.

Thereafter the information processing device 50 transmits a request for specific information through the network 7 in order to obtain the specific information 21 uniquely defined for each of the image formation devices including 10A and 10B (step S128). By way of example, this request for specific information is multicast to the plurality of image formation devices including 10A and 10B connected to the network 7. In the image formation device 10, upon receipt of this request for specific information (step S129), the device information output part 13 is brought into operation again in the CPU 11. The device information output part 13 reads the specific information 21 stored in the storage part 20 (step S130), and transmits the specific information 21 thereby read to the information processing device 50 (step S131). All of the image formation devices 10 connected to the network 7 transmit the specific information 21. Thus, each of the plurality of image formation devices including 10A and 10B independently transmits the specific information 21 to the information processing device 50.

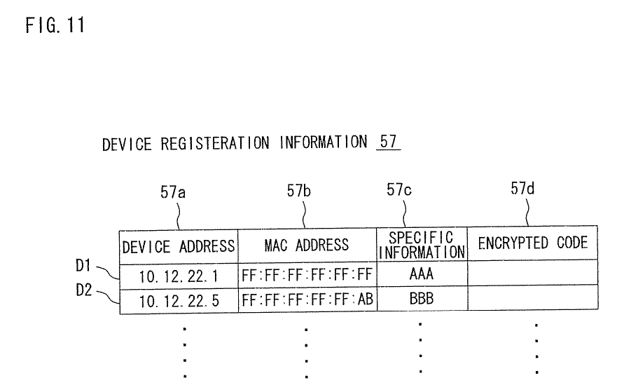

Upon receipt of the specific information 21 from each of the image formation devices 10 through the network 7 (step S132), the information processing device 50 associates the device address, the MAC address and the specific information 21 of each of the image formation devices 10. Then, the information processing device 50 stores these pieces of information as the device registration information 57 into the storage part 54 (step S133). The device registration information 57 thereby stored is associated with the license code selected in step S122. FIG. 11 shows an example of the device registration information 57 thereby stored in the storage part 54 of the information processing device 50. The device registration information 57 contains a device address 57a, a MAC address 57b, specific information 57c and an encrypted code 57d. The information entered by the process discussed above are the device address 57a, the MAC address 57b and the specific information 57c. The encrypted code 57d remains blank. With reference to FIG. 11, first registration information D1 of the device registration information 57 relates to the image formation device 10A (see FIG. 1), and second registration information D2 relates to the image formation device 10B. When the device registration information 57 is successfully entered in this way, this process for the entry is completed.

Following the process discussed above, the registration of the image formation device 10 with the information processing device 50 shown in FIG. 5 (process P14) is completed. The user 5 continues to operate the information processing device 50 to proceed to the process for enabling an optional function at the image formation device 10 (process P15). In this process, the user 5 operates the information processing device 50, so that the information processing device 50 transmits a request for issue of license together with the specific information 21 of the image formation device 10 to the license management server 40, and receives an encrypted license that has been encrypted using the specific information 21 from the license management server 40. Then, the information processing device 50 provides the image formation device 10 with this encrypted license code together with a function enabling command. The image formation device 10 authenticates the encrypted license code using the specific information 21 of its own. When the encrypted license code is recognized as a proper code, the image formation device 10 enables an optional function designated by the function enabling command.

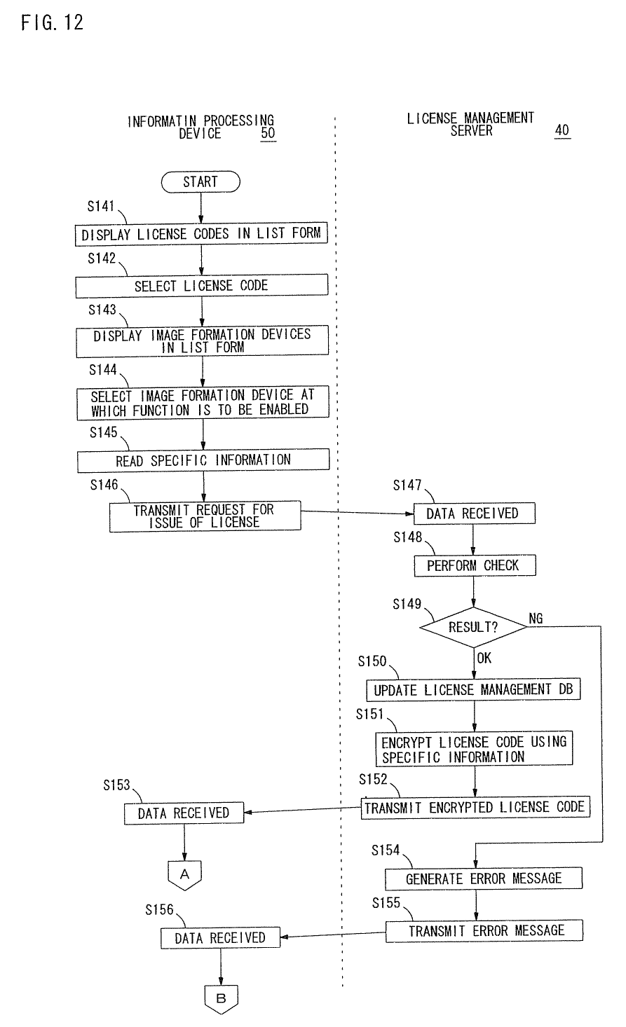

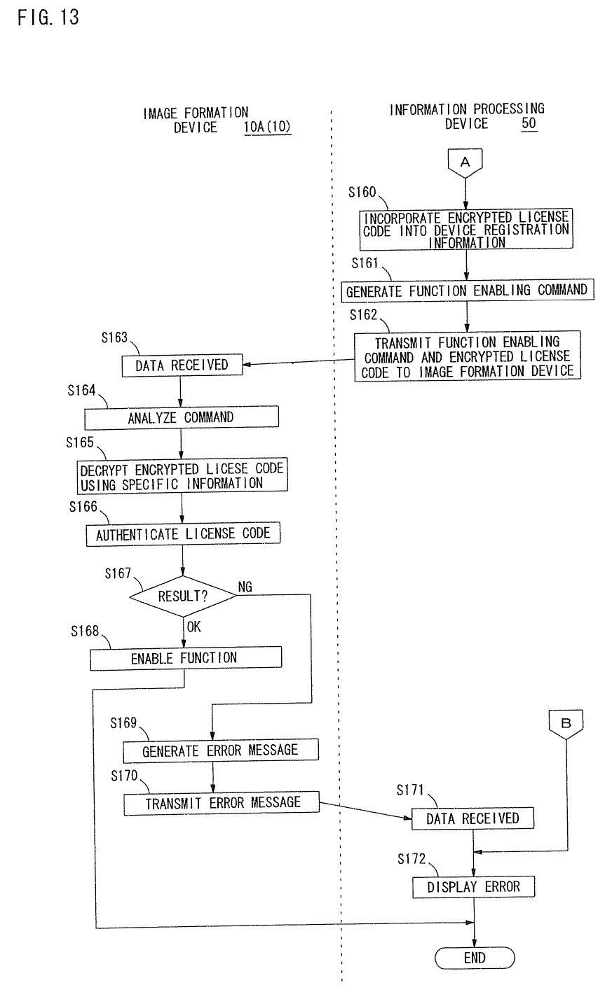

FIGS. 12 and 13 are flow diagrams showing an exemplary process sequence at the information processing device 50, the license management server 50 and the image formation device 10 for enabling an optional function of the image formation device 10. In the information processing device 50, the CPU 51 also executes the function management program 55 to start this process sequence. After the start of the process sequence, the function management part 52 is brought into operation in the CPU 51 of the information processing device 50 to read the license information 56 from the storage part 54. Thereafter license codes contained in the license information 56 are displayed in list form on the display device 61 (step S141). The user 5 operates the keyboard 62 and the like to select a license code corresponding to an optional function that the user 5 wishes to enable from the license codes displayed in list form on the display device 61 (step S142).

The information processing device 50 reads the device registration information 57 from the storage part 54 that is associated with the license code selected by the user 5, and causes the image formation devices 10 contained in the device registration information 57 to be displayed in list form on the display device 61 (step S143). The user 5 operates the keyboard 62 and the like to designate the image formation device 10 at which the user 5 wishes to enable the optional function from the image formation devices 10 displayed in list form on the display device 61 (step S144). At this time, two or more of the image formation devices 10 may be designated. For the simplification of the discussion given below, however, only the image formation device 10A is designated as an example.

When the image formation device 10A designated by the user 5 is selected, the image processing device 50 reads the specific information 57c corresponding to the image formation device 10A from the device registration information 57 (step S145). This specific information 57c coincides with the specific information 21 unique to the image formation device 10A. Thereafter the image processing device 50 transmits a request for issue of license together with the specific information 21 of the selected image formation device 10A to the license management server 40 (step S146). This request for issue of license contains information specifying the license code.

In the license management server 40, upon receipt of the request for issue of license from the information processing device 50 (step S147), the license management part 45 of the CPU 43 is brought into operation to search the license management database 42 (step S148). Namely, the license management part 45 searches the license management database 42 to check whether or not the license code specified by the request for issue of license is recorded therein. If this license code is recorded in the license management database 42, the license management part 45 performs a check to see that the number of unused licenses 42e (see FIG. 6) is 1 or more. If the number of unused licenses 42e is 1 or more, a result obtained in step S149 is OK. Then the license management part 45 updates the license management database 42 (step S150). Namely, the license management part 45 increases the number of used licenses 42d by 1 and decreases the number of unused licenses 42e by 1, thereby updating the license management database 42. When requests for issue of license regarding N (N is 2 or more) image formation devices are concurrently made, the license management part 45 performs checks (step S148) to see that the number of unused licenses 42e is N or more. If a result of checks is OK, the license management part 45 increases the number of used licenses 42d by N and decreases the number of unused licenses 42e by N to update the license management database 42 (step S150).

Thereafter the code generation part 46 is brought into operation in the CPU 43 of the license management server 40. The code generation part 46 reads the license code specified by the request for issue of license from the license management database 42, and encrypts this license code using the specific information 21 as a key that has been received together with the request for issue of license (step S151). The license code thereby becomes an encrypted license code that is encrypted using the specific information 21 (such as “AAA”, for example) as a key. This is an exemplary license code that is generated based on the specific information 21. The code generation part 46 transmits the license code thereby encrypted to the information processing device 50 (step S152), and the information processing device 50 receives the encrypted license code (step S153).

As a result of the checks at the license management server 40 (step S148), the license code specified by the request for issue of license may not be recorded in the license management database 42, or the number of unused licenses 42e may not be enough. In either case, a result obtained in step S149 is NG. Then, the license management part 45 generates an error message (step S154). This error message is transmitted from the license management server 40 (step S155), and is received by the information processing device 50 (step S156).

Referring next to the flow diagram shown in FIG. 13, when the information processing device 50 receives the encrypted license code from the license management server 40, the information processing device 50 incorporates the received encrypted license code into the device registration information 57 (step S160). Namely, in the device registration information 57 shown in FIG. 11, this encrypted license code fills in a blank for the encrypted code 57d of the registration information D1 corresponding to the image formation device 10A. Thereafter the command output part 53 is brought into operation in the CPU 51 of the information processing device 50. The command output part 53 generates a function enabling command for the image formation device 10A designated in step S144 (step S161), and transmits this function enabling command and the encrypted license code obtained from the license management server 40 to the image formation device 10A (step S162).

In the image formation device 10A, upon receipt of the function enabling command and the encrypted license code from the information processing device 50 (step S163), the command analysis part 12 conducts command analysis (step S164). When the command analysis part 12 determines that the received command is a function enabling command, the command analysis part 12 specifies the optional function to be enabled using information contained in the command. Then, the command analysis part 12 gives the encrypted license code that has been received together with the function enabling command to the code authentication part 14, by which the decryption part 15 of the code authentication part 14 is brought into operation. The decryption part 15 reads the specific information 21 from the storage part 20, and decrypts the encrypted license code using this specific information 21 as a key (step S165). That is, the encrypted license code is decrypted using the specific information 21 (such as “AAA”) as a key. As discussed above, the decrypted license code contains particular information when the decryption is successfully completed. The code authentication part 14 determines whether or not the decrypted license code is a proper code based on the presence or absence of such particular information (step S166).

A result obtained in step S167 is OK when the decrypted license code is recognized as a proper code. Then the function enabling part 16 is brought into operation in the CPU 11. The function enabling part 16 enables the optional function designated by the function enabling command, thereby making this optional function usable in the image formation device 10A (step S168). As a result, this optional function is effectively available in the image formation device 10A to complete the process for enabling the optional function.

When the decrypted license code is not recognized as a proper code, on the other hand, a result obtained in step S167 is NG. Then the code authentication part 14 generates an error message (step S169). This error message is transmitted from the image formation device 10A (step S170), and is received by the information processing device 50 (step S171).

When the information processing device 50 receives the error message from the license management server 40 (step S156), or from the image formation device 10A, the information processing device 50 causes the received error message to be displayed on the display device 61 (step S172). The information processing device 50 thereby informs the user 5 of the fact that the optional function has not successfully been enabled, and completes the process. When the user 5 tries to enable the optional function again, process steps starting from step S141 are repeated.

Following the process discussed above, an optional function is enabled in the image formation device 10A (process P15). In this process, the license management server 40 encrypts a license code using the specific information 21 uniquely defined for the image formation device 10A, thereby generating an encrypted license code applicable only to the image formation device 10A as discussed above. The image formation device 10A receives the encrypted license code input thereto, and decrypts this encrypted license code using the specific information 21 of its own, thereby determining whether or not the decrypted license code is a proper code. The image formation device 10A enables an optional function only when the decrypted license code is a proper code. Thus, a license code issued by the license management server 40 is not applied to other image formation devices such as the image formation device 10B, thereby allowing the license management server 40 to precisely manage the usage of a license.

In the present preferred embodiment, the image formation device 10A receives both a function enabling command and an encrypted license code. The image formation 10A may receive only an encrypted license code. In this case, the image formation device 10A first decrypts the encrypted license code to authenticate the decrypted license code. When the decrypted license code is recognized as a proper code, an optional function to be enabled is specified by the decrypted license code. Then, the function enabling part 16 enables the specified optional function.

Discussed next is the process of disabling an optional function in a condition where this optional function is effectively available in the image formation device 10. In this disabling process, the user 5 operates the information processing device 50, so that the information processing device 50 transmits a request for issue of a disabling code together with the specific information 21 of the image formation device 10 to the license management server 40, and obtains the disabling code that has been encrypted using the specific information 21 from the license management server 40. Then, the information processing device 50 provides the image formation device 10 with this encrypted disabling code together with a function disabling command. The image formation device 10 authenticates the encrypted disabling code using the specific information 21 of its own. When the encrypted disabling code is recognized as a proper code, the image formation device 10 disables an optional function designated by the function disabling command. Disabling the optional function causes the image formation device 10 to change the specific information 21 of its own to information different from previous information.

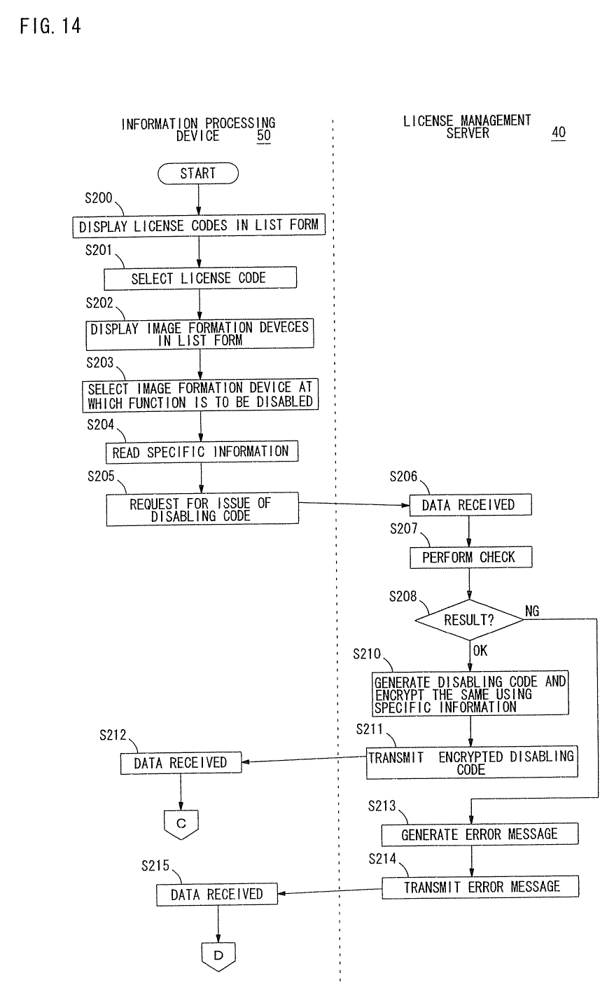

FIGS. 14 to 16 are flow diagrams showing an exemplary process sequence at the information processing device 50, the license management server 40 and the image formation device 10 for disabling an optional function of the image formation device 10. In the information processing device 50, the CPU 51 also executes the function management program 55 to start this process sequence. After the start of the process sequence, the function management part 52 is brought into operation in the CPU 51 of the information processing device 50 to read the license information 56 stored in the storage part 54. License codes contained in the license information 56 are displayed in list form on the display device 61 (step S200). The user 5 operates the keyboard 62 and the like to select a license code corresponding to an optional function that the user 5 wishes to disable from the license codes displayed in list form on the display device 61 (step S201).

The information processing device 50 reads the device registration information 57 from the storage part 54 that is associated with the license code selected by the user 5, and causes the image formation devices 10 contained in the device registration information 57 to be displayed in list form on the display device 61 (step S202). At this time, only the image formation devices 10 given encrypted license codes that fill columns for the encrypted code 57d of the device registration information 57 are extracted and displayed in list form. As a result, the image formation devices 10 at which the optional function selected by the user 5 is effectively available are displayed in list form on the display device 61. Then, the user 5 operates the keyboard 62 and the like to designate the image formation device 10 at which the user 5 wishes to disable the optional function from the image formation devices 10 displayed in list form on the display device 61 (step S203). At this time, two or more of the image formation devices 10 may be designated. For the simplification of the discussion given below, however, only the image formation device 10A is designated as an example.

When the image formation device 10A designated by the user 5 is selected, the image processing device 50 reads the specific information 57c of the image formation device 10A contained in the device registration information 57 (step S204). This specific information 57c coincides with the specific information 21 of the image formation device 10A stored therein. Thereafter the image processing device 50 transmits a request for issue of a disabling code together with the specific information 21 of the selected image formation device 10A to the license management server 40 (step S205). This request for issue of a disabling code contains information specifying the license code corresponding to the optional function to be disabled.

In the license management server 40, upon receipt of the request for issue of a disabling code from the information processing device 50 (step S206), the license management part 45 of the CPU 43 is brought into operation to search the license management database 42 (step S207). Namely, the license management part 45 searches the license management database 42 to check whether or not the license code specified by the request for issue of a disabling code is recorded therein. If this license code is recorded in the license management database 42, the license management part 45 performs a check to see that the number of used licenses 42d (see FIG. 6) is 1 or more. If the number of used licenses 42d is 1 or more, a result obtained in step S208 is OK. Thereafter the code generation part 46 is brought into operation in the CPU 43 of the license management server 40. The code generation part 46 generates a disabling code for disabling an optional function corresponding to the specified license code, and encrypts this disabling code using the specific information 21 as a key that has been received together with the request for issue of a disabling code (step S210). The disabling code thereby becomes an encrypted code that is encrypted using the specific information 21 (such as “AAA”, for example) as a key. The code generation part 46 transmits the disabling code thereby encrypted to the information processing device 50 (step S211), and the information processing device 50 receives the encrypted disabling code (step S212).

As a result of the checks at the license management server 40 (step S207), the license code specified by the request for issue of a disabling code may not be recorded in the license management database 42, or the number of issued licenses 42d may be zero. In either case, a result obtained in step S208 is NG, and the license management part 45 generates an error message (step S213). This error message is transmitted from the license management server 40 (step S214), and is received by the information processing device 50 (step S215).

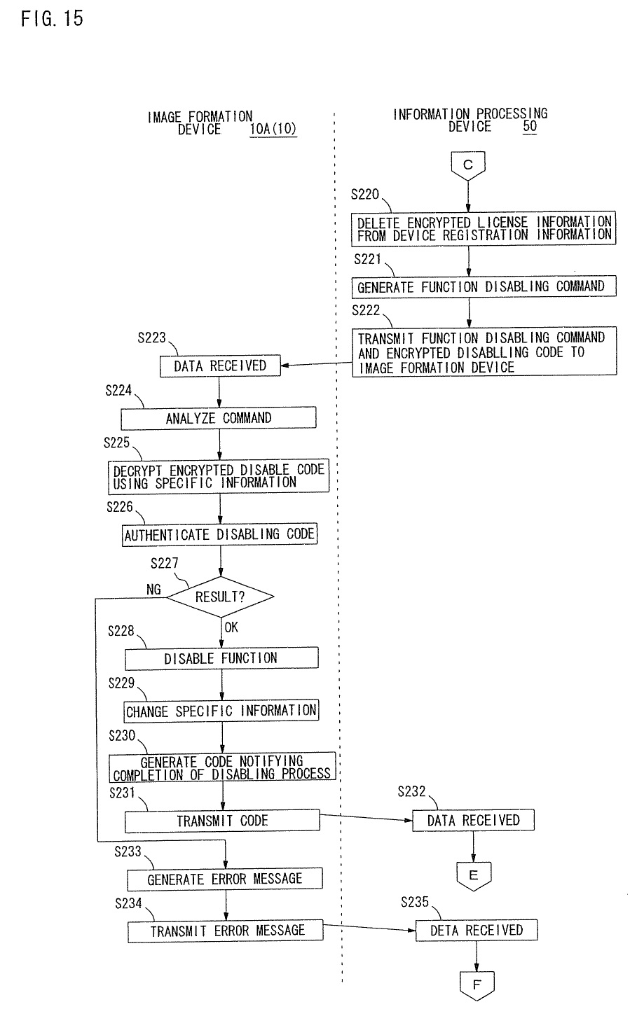

Referring next to the flow diagram shown in FIG. 15, when the information processing device 50 receives the encrypted disabling code from the license management server 40, the information processing device 50 deletes the encrypted license code of the image formation device 10A contained in the device registration information 57 (step S220). As a result, in the device registration information 57 shown in FIG. 11, a column for the encrypted code 57d of the registration information D1 corresponding to the image formation device 10A returns to a blank column. Thereafter the command output part 53 is brought into operation in the CPU 51 of the information processing device 50. The command output part 53 generates a function disabling command for the image formation device 10A (step S221). This function disabling command designates the optional function to be disabled. The information processing device 50 transmits this function disabling command and the encrypted disabling code obtained from the license management server 40 to the image formation device 10A (step S222).

In the image formation device 10A, upon receipt of the function disabling command and the encrypted disabling command from the information processing device 50 (step S223), the command analysis part 12 conducts command analysis (step S224). When the command analysis part 12 determines that the received command is a function disabling command, the command analysis part 12 specifies the optional function to be disabled using information contained in the command. Then, the command analysis part 12 gives the encrypted disabling code that has been received together with the function disabling command to the code authentication part 14, by which the decryption part 15 of the code authentication part 14 is brought into operation. The decryption part 15 reads the specific information 21 from the storage part 20, and decrypts the encrypted disabling code using this specific information 21 as a key (step S225). That is, the encrypted disabling code is decrypted using the specific information 21 (such as “AAA”) as a key. As discussed above, the decrypted disabling code contains particular information when the decryption is successfully completed. The code authentication part 14 determines whether or not the decrypted disabling code is a proper code based on the presence or absence of such particular information (step S226).

A result obtained in step S227 is OK when the decrypted disabling code is recognized as a proper code. Then the function disabling part 17 is brought into operation in the CPU 11. The function disabling part 17 disables the optional function designated by the function disabling command, thereby making this optional function unusable in the image formation device 10A (step S228). As a result, this optional function is unavailable in the image formation device 10A, and cannot be used by the user 5 accordingly.

Thereafter the specific information rewriting part 18 is brought into operation in the function disabling part 17. Disabling the optional function that has been valid causes the specific information rewiring part 18 to rewrite the specific information 21 stored in the storage part 20, thereby changing the specific information of the image formation device 10A (step S229). As an example, the specific information 21 is changed from “AAA” to “ZZZ.” The specific information 21 after having been rewritten by the specific information rewriting part 18 is still unique to the image formation device 10A, at least in an environment where the image formation device 10A is connected to the network 7. The specific information 21 may be defined in any manner. As an example, the device identification information of the image formation device 10A such as MAC address or serial number, and temporal information such as year, month, day, time, minute and second at which the specific information 21 is generated are computed based on a certain rule. Resultant information obtained therefrom is applied as new specific information. The specific information rewriting part 18 thereby changes the specific information 21 stored in the storage part 20, so that in the image formation device 10A, the above-discussed optional function cannot be enabled again using an encrypted license code previously authenticated.

Thereafter the function disabling part 17 generates a code notifying the completion of disabling process (step S230), and transmits this code to the information processing device 50 (step S231). This code is received by the information processing device 50 (step S232).

When the decrypted disabling code is not recognized as a proper code, on the other hand, a result obtained in step S227 is NG. Then the code authentication part 14 generates an error message (step S233). This error message is transmitted from the image formation device 10A (step S234), and is received by the information processing device 50 (step S235).

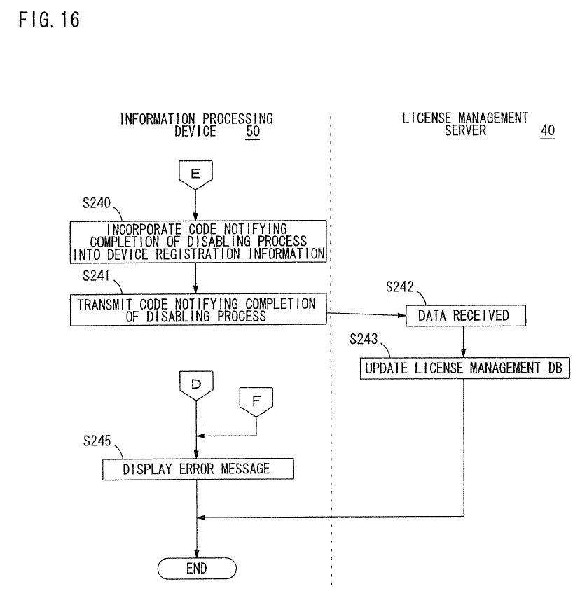

Referring next to the flow diagram shown in FIG. 16, upon receipt of the code notifying the completion of disabling process from the image formation device 10A, the information processing device 50 incorporates this code into the device registration information 57 (step S240). By way of example, this code is incorporated into a column for the encrypted code 57d of the device registration information 57. As a result, the information processing device 50 is allowed to determine whether or not the optional function is valid or invalid in each of the image formation devices 10 contained in the device registration information 57 by referring to the device registration information 57. Thereafter the information processing device 50 transmits the code notifying the completion of disabling process to the license management server 40 (step S241). Upon receipt of the code notifying the completion of disabling process from the information processing device 50 (step S242), the license management server 40 updates the license management database 42 (step S243). Namely, in the license information L1 shown in FIG. 6, the number of used licenses 42d is decreased by 1 and the number of unused licenses 42e is increased by 1, thereby updating the license management database 42. As a result, a license corresponding to the disabled optional function is stored as an unused license in the license management database 42.

When the information processing device 50 receives the error message from the license management server 40 (step S215), or from the image formation device 10A (step S235), the information processing device 50 causes the received error message to be displayed on the display device 61 (step S245). The information processing device 50 thereby informs the user 5 of the fact that the optional function has not successfully been disabled, and completes the process. When the user 5 tries to disable the optional function again, process steps starting from step S200 are repeated.

Following the process discussed above, an optional function is disabled in the image formation device 10A. In this process, the license management server 40 encrypts a disabling code using the specific information 21 uniquely defined for the image formation device 10A, thereby generating an encrypted disabling code applicable only to the image formation device 10A as discussed above. The image formation device 10A receives the encrypted disabling code input thereto, and decrypts this encrypted disabling code using the specific information 21 of its own, thereby determining whether or not the decrypted disabling code is a proper code. The image formation device 10A disables an optional function only when the decrypted disabling code is a proper code. Thus, a disabling code issued by the license management server 40 is not applied to other image formation devices such as the image formation device 10B, thereby allowing the license management server 40 to precisely manage the usage of a license.

In the present preferred embodiment, the disabling process of an optional function causes the specific information 21 stored in the storage part 20 of the image formation device 10 and uniquely defined for the image formation device 10 to be changed to information different from previous information. When the same optional function is to be enabled again in the image formation device 10, a license code encrypted by using the specific information 21 as changed should be given from the license management server 40. This prevents an encrypted license code once issued from being used repeatedly in the office environment 3 of the user 5. As a result, the license management server 40 is allowed to precisely manage the usage of a license at all times.

Discussed next is the transfer of a license. As discussed above, when an optional function is disabled in a condition where this optional function is effectively available in the image formation device 10, the license management server 40 regards a license corresponding to the disabled optional function as an unused license. As an example, after an optional function is disabled in the image formation device 10A, a license corresponding to the disabled optional function may be used in the different image formation device 10B to enable this optional function. In this case, the license is transferred between the image formation devices 10.

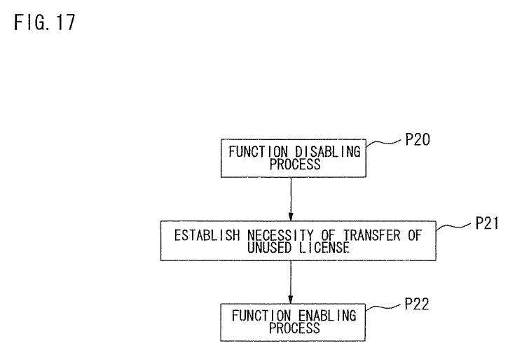

FIG. 17 is a flow diagram showing the transfer process of a license. For the transfer of a license, the user 5 first operates the information processing device 50 to conduct the function disabling process (process P20). This function disabling process (process P20) follows the same steps discussed in detail above with reference to the flow diagrams of FIGS. 14 to 16. This function disabling process generates an unused license, and the license management server 40 allows this license corresponding to a disabled optional function to be given to a different image formation device.

Thereafter, the necessity of transfer of the unused license is established (process P21). As an example, confirmation massage is displayed on the display device 61 of the information processing device 50 to determine whether or not the license should be transferred, thereby establishing the necessity of transfer. When the user 5 gives instruction to transfer the license, function enabling process is conducted in which the license is transferred to a different image formation device to enable the optional function in this image formation device (process P22). This function enabling process (process P22) is the same as the function enabling process shown in FIG. 5 (process P15), and follows the same steps discussed in detail above with reference to the flow diagrams of FIGS. 12 and 13. This function enabling process causes the unused license to be applied to the different image formation device 10 designated by the user 5 at which the optional function is to be enabled.

Following the process discussed above, a license is freely transferred between the plurality of image formation devices 10 installed in the office environment 3. Thus, within the number of licenses already purchased and without the need of purchasing an additional license, the user 5 is allowed to suitably change the image formation device 10 at which an optional function is to be effectively available. As a result, the user 5 is allowed to efficiently use a license.

As discussed above, the image formation device 10 of the present preferred embodiment includes the specific information 21 stored in the storage part 20 that is uniquely defined for the image formation device 10. The image formation device 10 receives a license code input thereto that is generated based on this specific information 21 by the license management server 40, and authenticates the received license code using the specific information 21 in the storage part 20. When the received license code is recognized as a proper license code as a result of authentication, the image formation device 10 enables a designated optional function. The image formation device 10 also disables an optional function that has been enabled by a license code. Disabling the optional function causes the image formation device 10 to change the specific information 21 stored in the storage part 20 to information different from previous information. Thus, after disabling the optional function, the image formation device 10 does not recognize a license code input thereto as a proper license code that had been granted before the optional function is disabled. As a result, the optional function is prevented from being enabled twice using the same license code.

In order to disable an optional function, the image formation device 10 receives a disabling code input thereto that is generated based on the specific information 21 by the license management server 40, and authenticates the received disabling code using the specific information 21 in the storage part 20. When the received disabling code is recognized as a disabling proper code as a result of authentication, the image formation device 10 disables a designated optional function. In order to enable or disable an optional function in the image formation device 10, the image formation device 10 should receive a code that is issued each time the optional function is enabled or disabled. After the specific information 21 is changed, a code that is generated based on the previous information fails to enable or disable the optional function. This means enabling or disabling an optional function in the image formation device 10 always requires the issue of a code by the license management server 40. As a result, the license management server 40 is allowed to precisely manage the usage of a license at all times.

### Modifications

In the preferred embodiment discussed above, data communication between the image formation device 10 and the license management server 40 is realized through the information processing device 50. Namely, in the preferred embodiment discussed above, the license management server 40 conducts data communication with the image formation devices 10 indirectly through the information processing device 50 and not directly with the image formation devices 10, thereby managing the usage of licenses at the image formation devices 10. Alternatively, the license management server 40 may conduct data communication directly with the image formation devices 10 without involving the information processing device 50. In this case, the function of the information processing device 50 as discussed above may be provided in the license management server 40, or in the image formation device 10. When the function of the information processing device 50 is to be provided in the image formation device 10, any one of the plurality of image formation devices 10 installed in the office environment 3 may have the function of the information processing device 50.

While the invention has been shown and described in detail, the foregoing description is in all aspects illustrative and not restrictive. It is therefore understood that numerous modifications and variations can be devised without departing from the scope of the invention.

What is claimed is:

1. An image formation device for enabling an optional function that is invalid in an initial state with the entry of a license code, said image formation device comprising:
a storage part for storing specific information unique to said image formation device;
an input part for receiving a license code input thereto that is generated based on said specific information;
an authentication part for authenticating said license code received through said input part using said specific information stored in said storage part;
a function enabling part for enabling an optional function when said authentication part recognizes said license code as a proper license code; and
a function disabling part for disabling said optional function that has been enabled by said function enabling part and changing said specific information stored in said storage part.

2. The image formation device according to claim 1, wherein
said authentication part authenticates a disabling code received through said input part using said specific information stored in said storage part, and
said function disabling part disables said optional function that has been enabled by said function enabling part when said authentication part recognizes said disabling code as a proper disabling code.

3. The image formation device according to claim 1, wherein
said function disabling part generates and outputs a code notifying the completion of disabling process after said function disabling part disables said optional function that has been enabled by said function enabling part.

4. The image formation device according to claim 1, wherein
said license code is an encrypted code that is encrypted using said specific information stored in said storage part as a key, and
said authentication part decrypts said license code received through said input part using said specific information stored in said storage part as a key.

5. A license management system comprising an image formation device and a license management server connected through a network to said image formation device, said image formation device enabling an optional function that is invalid in an initial state with the entry of a license code, said license management server issuing a license and transmitting a license code to said image formation device, while managing the usage of a license relating to said optional function,
said image formation device including:
a storage part for storing specific information unique to said image formation device;
an input part for receiving a license code input thereto through said network;
an authentication part for authenticating said license code received through said input part using said specific information stored in said storage part;
a function enabling part for enabling an optional function when said authentication part recognizes said license code as a proper license code; and
a function disabling part for disabling said optional function that has been enabled by said function enabling part,
said license management server including:
a license management database for storing the usage of a license;
a specific information retrieval part for retrieving said specific information stored in said storage part from said image formation device through said network;
a code generation part for generating a license code used to enable an optional function based on said specific information retrieved by said specific information retrieval part;
a transmission part for transmitting said license code generated by said code generation part to said image formation device; and
a license management part being caused by the transmission of said license code to update said license management database, wherein
said function disabling part changes said specific information stored said storage part after disabling said optional function.

6. The license management system according to claim 5, wherein
in said license management server, said code generation part also generates a disabling code for disabling an optional function based on said specific information retrieved by said specific information retrieval part, and said transmission part transmits said disabling code generated by said code generation part to said image formation device, and
in said image formation device, said authentication part authenticates said disabling code received through said input part using said specific information stored in said storage part, and said function disabling part disables said optional function that has been enabled by said function enabling part when said authentication part recognizes said disabling code as a proper disabling code.

7. The license management system according to claim 5, wherein
in said image formation device, said function disabling part generates and outputs a code notifying the completion of disabling process after said function disabling part disables said optional function that has been enabled by said function enabling part, and
in said license management server, said license management part updates said license management database upon receipt of said code notifying the completion of disabling process.

8. The license management system according to claim 7, wherein said license management part updates said license management database upon receipt of said code notifying the completion of disabling process to allow a license corresponding to the disabled optional function to be given to a different image formation device.

9. The license management system according to claim 5, wherein
said code generation part includes a code encryption part for encrypting a license code using said specific information stored in said storage part as a key, and
said authentication part decrypts said license code received through said input part using said specific information stored in said storage part.

10. A license management system, comprising:
an image formation device including a storage part for storing specific information unique to said image formation device, and enabling an optional function that is invalid in an initial state with the entry of a license code;
a license management server issuing a license code corresponding to said optional function of said image formation device, and managing the usage of a license at said image formation device; and
an information processing device so connected to said image formation device and said license management server as to realize data communication with said image formation device and said license management server,
for enabling said optional function of said image formation device,
said information processing device retrieving said specific information from said image formation device, and transmitting a request for issue of a license code together with said specific information to said license management server,
said license management server generating said license code for enabling said optional function of said image formation device based on said specific information, and transmitting said license code to said information processing device,
said information processing device outputting said license code received from said license management server and a function enabling command to said image formation device, and
said image formation device authenticating said license code received from said information processing device using said specific information stored in said storage part, and enabling said optional function when said license code is recognized as a proper code,
for disabling said optional function of said image formation device,
said information processing device transmitting a request for issue of a disabling code together with said specific information to said license management server,
said license management server generating said disabling code for disabling said optional function of said image formation device based on said specific information, and transmitting said disabling code to said information processing device,
said information processing device outputting said disabling code received from said license management server and a function disabling command to said image formation device, and
said image formation device authenticating said disabling code received from said information processing device using said specific information stored in said storage part, disabling said optional function when said disabling code is recognized a proper code, and changing said specific information stored in said storage part to information different from previous information.
